(19) United States
(12) Patent Application Publication
(10) Pub. No.: US 2003/0167357 A1
(43) Pub. Date: Sep. 4, 2003

(54) Enhancement of source code for execution on a computer platform that has a capability of employing a memory file

(75) Inventor: David Harold Goode, San Jose, CA (US)

Correspondence Address: Paul D Greeley, Esq., Ohlandt, Greeley, Ruggiero & Perle, L.L.P., 10th Floor, One Landmark Square, Stamford, CT, 06901-2682, US

(73) Assignee: INTERNATIONAL BUSINESS MACHINES CORPORATION

(21) Appl. No.: 10/090,236

(22) Filed: Mar. 4, 2002

(51) Int. Cl. G06F 9/46; G06F 9/45

(52) U.S. Cl. 709/328; 717/152; 717/137

(57) ABSTRACT

There is provided a method for enhancing source code for execution on a computer platform that has a capability to employ a memory file. The method includes the steps of recognizing an occurrence of a first instruction in the source code that does not utilize the capability, and supplementing the source code with a second instruction that utilizes the capability.

### BACKGROUND OF THE INVENTION

1. Field of the Invention

The present invention relates to source code for execution on a computer system, and more particularly, to an enhancement of source code for execution on a computer platform that has a capability to employ a memory file.

2. Description of the Prior Art

Some processing systems operate on data formatted as Extended Binary Coded Decimal Information Code (EBCDIC). User IDs, passwords, data set names, job control language (JCL), and virtually all other data must be formatted in EBCDIC, or converted to EBCDIC in order to be processed. For example, UNIX™ S/390™ and IBM™ z/OS™ operate on EBCDIC formatted data.

“Porting” is a task of adapting software code for a different platform than the one on which the code was originally developed. When a team ports code from a non-S/390 UNIX environment to UNIX System Services on S/390, the porting team must decide whether the resulting code will run in American Standard Code for Information Interchange (ASCII) or EBCDIC mode. Generally speaking, far less code modification will be required if the code can run in ASCII.

On S/390 developers have the option of using a _LIBASCII feature test macro, which provides an ASCII-like environment for many C/C++ functions. In order to use _LIBASCII, the macro must be added to a portion of code as follows:

#define _LIBASCII

Then the code must be recompiled using an option, i.e., the -D_STRING_CODE_SET_=“IS088591” option, which causes a compiler to generate all strings defined in a source program in ASCII rather than EBCDIC. This option can greatly simplify a task of porting code to S/390 and z/OS from other UNIX platforms, since all other UNIX platforms support only an ASCII environment. If the _LIBASCII option is chosen, however, code complexities may be introduced if an application must read or write text files containing multibyte characters, because of the fundamentally different methods of EBCDIC and ASCII representation of such files. Specifically, EBCDIC representation of text containing multi-byte characters incorporates state information into the text stream itself in the form of shift-in and shift-out characters, while ASCII representation uses no such state-transition characters. The presence of a shift-out state-transition character indicates that all characters that follow are multi-byte characters until a shift-in character is present. In ASCII text streams, single-byte characters are distinguishable from multi-byte characters because no single-byte character value can be the value of the first byte of a multi-byte character. Consequently, an ASCII text stream n bytes in size, when converted to EBCDIC may grow to be 2n−1 bytes in size. However, this theoretical size increment can be reached only if every single-byte character is followed by a multi-byte character, and vice-versa.

A problem can arise if a file or text stream containing both single- and multi-byte characters is processed in incremental portions of fixed size, for instance, in network buffers or in fixed-size buffers used to read a file or files. Specifically, using a fixed-size buffer to read an ASCII stream or file that must be converted to EBCDIC will probably result at some point in the last character in the buffer being the first half of a multi-byte character. In this state, the conversion operation on that buffer will fail. Other difficulties must be considered as well, such as the possible size difference between the same strings in EBCDIC and ASCII mentioned above, and the requirement that state information must be maintained for EBCDIC, but not for ASCII strings. The present invention, while not primarily motivated by this class of problems, suggests a simple expedient to surmount all such issues.

### SUMMARY OF THE INVENTION

It is an object of the present invention to provide an optimization technique that minimizes the cost associated with code that performs a plurality of non-sequential writes and reads to and from a permanent file.

It is another object of the present invention to provide such a technique that minimizes the complexity associated with code that works with text files by reducing a number of conversion operations between EBCDIC and ASCII data formats and a number of file input/outputs.

It is still a further object of the present invention to provide such a technique for use by applications in an S/390 system environment.

These and other objects of the present invention are achieved by a method for enhancing source code for execution on a computer platform that has a capability to employ a memory file. The method includes the steps of recognizing an occurrence of a first instruction in the source code that does not utilize the capability, and supplementing the source code with a second instruction that utilizes the capability.

### BRIEF DESCRIPTION OF THE DRAWINGS

FIG. 1 is a top-level block diagram of a system for porting code from a first source file to a second source file, in accordance with the present invention.

FIG. 2 is a diagram of a portion of a source file into which a porting operation has incorporated improved code.

FIGS. 3A and 3B are a flowchart of a process for using a memory file, instead of a permanent file, as a temporary work file, in accordance with the present invention.

FIG. 4 is a flowchart of a process for converting data from EBCDIC to ASCII, which can be incorporated into a ported source file in accordance with the present invention.

FIGS. 5A and 5B are a flowchart of a process for allocating a memory file into which ASCII text can be written.

FIG. 6 is a block diagram of a computer system configured for employment of the present invention.

### DESCRIPTION OF THE INVENTION

The present invention minimizes the cost associated with code that performs a plurality of non-sequential writes and reads to and from a permanent file. It also minimizes the complexity associated with code that works with text files containing multi-byte characters by reducing a number of conversion operations to a single conversion operation and a number of file input/outputs (I/O's) to a single read, and, if appropriate, a single write. The present invention is particularly well suited for use by applications in an S/390 system environment where_LIBASCII code is employed.

A memory file is a file that resides in memory only, as opposed to a permanent file, which resides on a disk or some other permanent storage media (hard drive, compact disk (CD), diskette, etc.). Because memory access is several orders of magnitude faster than I/O to permanent storage media, there is a potential performance gain to be achieved if a memory file is used where a permanent file is ordinarily used.

In UNIX System Services on S/390 and z/OS, memory files can be opened, read, written to, or otherwise manipulated and managed with exactly the same stream-oriented Application Programming Interfaces (APIs) that are available for permanent files. As a result, when software code is adapted for a different platform than the one on which the code was originally developed, that is, “ported”, the task of converting from use of permanent files to memory files is relatively simple. Those skilled in the art will appreciate that if the code being ported utilizes file-handling APIs based on file descriptors rather than streams, those file-descriptor API calls would have to be converted to their stream-oriented counterparts.

The present invention minimizes the cost associated with code that performs a plurality of non-sequential writes and reads to and from a permanent file by using a memory file instead of a permanent file as a temporary work file. Use of a memory file as a temporary work file offers a performance advantage in direct proportion to a degree to which a file is accessed in a non-sequential fashion. If an application merely writes to a file sequentially, there is little to be gained by writing to memory, and then writing from memory to a permanent storage medium. But if processing of the file requires repeated access to different locations within the file, say first at the beginning, then the end, then the middle, then a quarter of the way into the file, and so on, jumping forwards and backwards, then the time difference between accessing memory and accessing, say, a hard drive becomes significant.

If the file in question is being processed sequentially, for instance by using fgets( ), or by using fread( ) without any intervening fseeks, implementing the method described herein will probably yield no performance improvement. However, if the following two conditions are true:

(1) the code being ported performs non-sequential access; and

(2) the file is not so large that the method cannot obtain sufficient memory,

then the greater the size of the file, the greater the performance gain.

The memory file capability in UNIX System Services on S/390 can easily be taken advantage of and provide significant performance gains when application software is adapted (ported) from other UNIX platforms, where memory files are not available.

As mentioned earlier, the present invention also minimizes the complexity associated with code that works with text files containing multi-byte characters. More specifically, the present invention reduces a number of conversion operations to a single conversion operation and a number of file input/outputs (IO's) to a single read, and, if appropriate, a single write.

The present invention is of particular value when dealing with multi-byte codesets because the complexities described above that arise when doing incremental conversions that use fixed-size buffers can be eliminated. If the application being ported must deal with a stream of data, for instance, in the form of a series of incoming network buffers, a situation can arise where the last character in the network buffer is the first byte of a multi-byte character. In this situation, if a conversion is being performed on each buffer as it arrives, conversion software, e.g., an iconv API, will report an error, and the application code must implement special processing to be able to recover when the next buffer arrives. Using methods described herein, no such special code is required, since the entire file can be written in ASCII first, and then converted as a single entity to its EBCDIC form, or vice versa.

One embodiment of the present invention is a method for enhancing source code for execution on a computer platform that has a capability to employ a memory file. The method includes the steps of recognizing an occurrence of a first instruction in the source code that does not utilize the capability, and supplementing the source code with a second instruction that utilizes the capability. A system and a storage media for employing this method are also described.

Another embodiment of the present invention is a method for enhancing source code for execution on a computer platform that has a capability to employ a memory file. The method includes the steps of recognizing an occurrence of a first instruction in the source code that does not utilize the capability, and supplementing the source code with a module that opens a memory file for use as a temporary work file during execution of the source code. The recognizing and supplementing are performed when porting the source code from a first source file to a second source file. A system and a storage media for employing this method are also described.

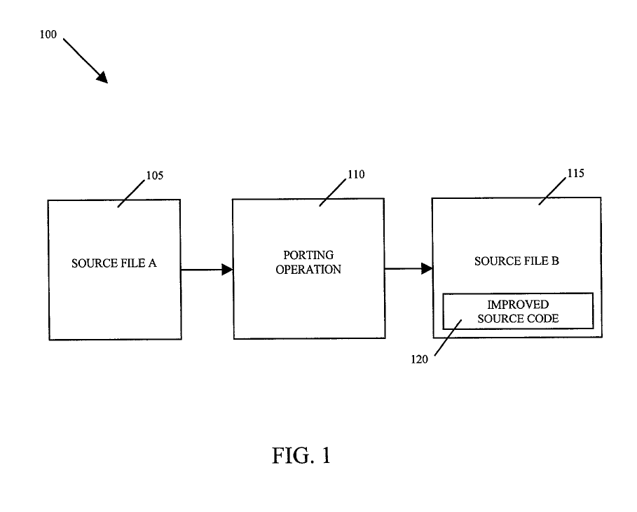

FIG. 1 is a top-level block diagram of a system 100 for porting code from a first source file to a second source file, in accordance with the present invention. System 100 includes a porting operation 110 that receives a source file A 105 and produces a source file B 115 for execution on a target platform that has a memory file capability, such as a UNIX198 S/390™ or IBM™ z/OS™. Porting operation 110 incorporates improved code 120 into source file B 115. Improved code 120 takes advantage of the memory file capability of the target platform.

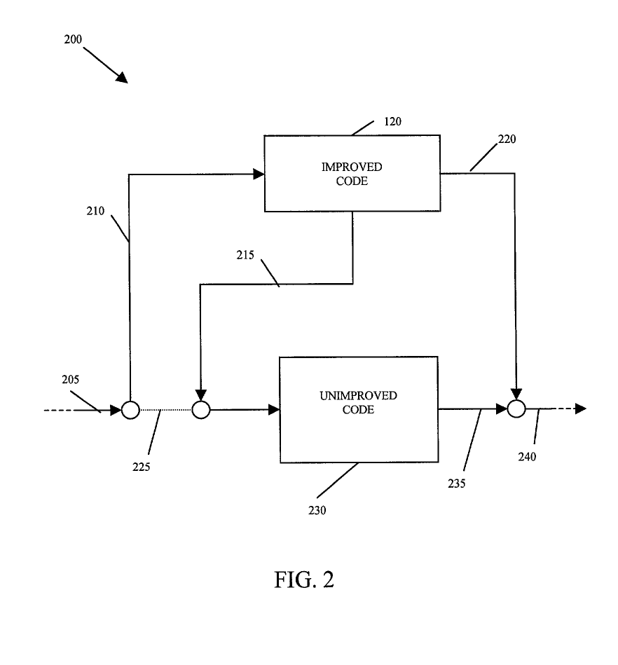

FIG. 2 is a diagram of a portion 200 of source file B 115 into which porting operation 110 has incorporated improved code 120. FIG. 2 is helpful in explaining how the incorporation of improved code 120 is accomplished.

Note that improved code 120 need not be physically located within portion 200, but instead could be physically located external to portion 200, and even external to source file B 115. For example, improved code 120 could be an external routine invoked by a call from within portion 200.

Portion 200 includes unimproved code 230, which is a module of code that includes an instruction or API (a candidate instruction) that does not use the memory file capability of the target platform, yet has a counterpart instruction or API that does take advantage of the memory file capability. Such a candidate instruction and its counterpart are, for example:

FILE *stream;

If ((stream =fopen(“testfile.dat”, “wb”))==NULL) perror(“Unable to open data file”);

and its memory-file counterpart:

If ((stream =fopen(“testfile.dat”, “wb”, type=memory))==NULL) perror(“Unable to open data file”);

Porting operation 110 examines source code file B 115 to locate unimproved code 230 with the candidate instruction therein. When porting operation 110 finds unimproved code 230, it installs improved code 120, or a call thereto, for execution as an alternative to unimproved code 230.

FIG. 2 also shows how a flow of execution of code through portion 200 would proceed. The execution of portion 200 commences along a path 205, and had improved code 120 not been incorporated by porting operation 110, the execution would proceed from path 205 along a path 225 to unimproved code 230. However, porting operation 110, when incorporating improved code 120, deletes or circumvents path 225, and provides a path 210 to improved code 120.

As explained below, the execution of improved code 120 can be completed either successfully or unsuccessfully. If improved code 120 executes successfully, then execution of portion 200 proceeds along path 220 and onward along path 240. If improved code 120 does not execute successfully, then execution of portion 200 proceeds along path 215 into unimproved code 230, and thereafter, from unimproved code 230 along path 235 and onward along path 240.

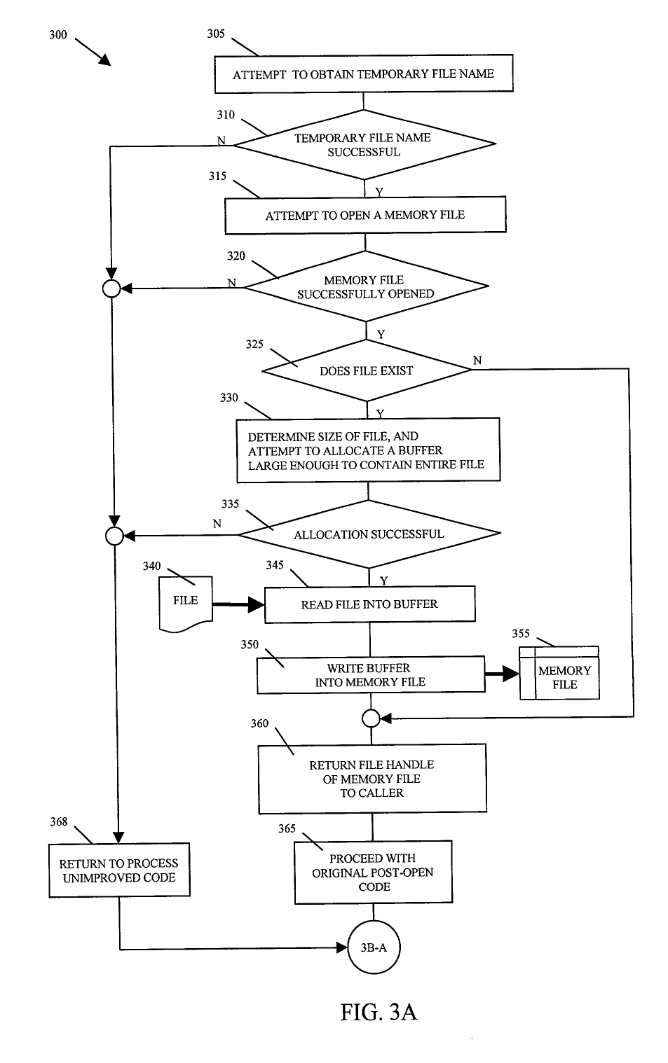

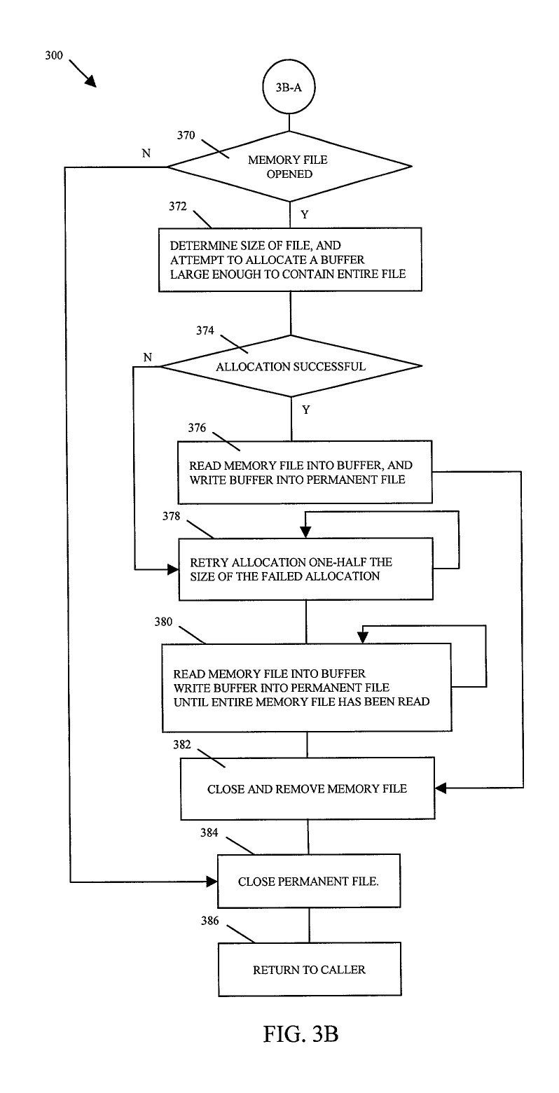

FIGS. 3A and 3B are a flowchart of a process 300 for using a memory file 355, instead of a permanent file 340, as a temporary work file, in accordance with the present invention. Process 300 is a first exemplary implementation of improved code 120 as can incorporated into a ported source file B 115 (see FIGS. 1 and 2). Process 300 is executed during execution of source file B 115, and it is particularly useful when a plurality of non-sequential reads and/or writes of a file, i.e., ordinarily permanent file 340, are to be performed.

FIG. 3A illustrates a front-end portion of process 300 for opening memory file 355, and FIG. 3B illustrates a back-end portion of process 300 for closing permanent file 340 and/or memory file 355. The front-end portion of process 300 begins with step 305.

In step 305, process 300 attempts to obtain a (unique) temporary file name. Process 300 then advances to step 310.

In step 310, process 300 determines whether the temporary file name was successfully obtained in step 305. If the temporary file name was successfully obtained, then process 300 advances to step 315. If the temporary file name was not successfully obtained, then process 300 branches to step 368.

In step 315, process 300 attempts to open memory file 355 using the temporary file name obtained in step 305. Process 300 then advances to step 320.

In step 320, process 300 determines whether the attempted opening of memory file 355 in step 315 was successful. If memory file 355 was successfully opened, then process 300 advances to step 325. If memory file 355 was not successfully opened, then process 300 branches to step 368.

In step 325, process 300 determines whether permanent file 340 already exists. Permanent file 340 might not exist, for example, in a case where process 300 reads an input text stream from a user interface, a network connection or a database. If permanent file 340 exists, then process 300 advances to step 330. If permanent file 340 does not exist, then process 300 branches to step 360.

In step 330, process 300 determines the size of permanent file 340 and attempts to allocate a buffer large enough to read in the entire permanent file 340. Process 300 then advances to step 335.

In step 335, process 300 determines whether the attempted allocation of a buffer in step 330 was successful. If the allocation was successful, then process 300 advances to step 345. If the allocation was not successful, because of a memory constraint for example, then process 300 branches to step 368.

In step 345, process 300 reads the entire permanent file 340 into the buffer that was allocated in step 330. Process 300 then advances to step 350.

In step 350, process 300 writes the entire contents of the allocated buffer into memory file 355. This step effectively completes atransfer of the contents of permanent file 340 into a temporary work file, i.e., memory file 355. Process 300 then advances to step 360.

In step 360, process 300 returns a file handle of memory file 355 to the code from which process 300 was called. Process 300 then advances to step 365.

In step 365, process 300 returns to the code from which it was called. For example, with reference to FIG. 2, upon successful completion of improved code 120, execution of portion 200 proceeds along path 220. Memory file 355 can now be accessed as if it were permanent file 340.

In step 368, process 300 reverts to normal, non-memory file processing. For example, with reference to FIG. 2, where improved code 120 is not successfully executed, execution of portion 200 proceeds from improved code 120 along path 215, and continues with execution of unimproved code 230. After the unimproved code is processed, the back-end portion of method 300 is invoked, commencing with step 370.

As mentioned above, FIG. 3B illustrates the back-end portion of process 300 for closing permanent file 340 and/or memory file 355, for example, after the processes to which step 365 returned have run their course. When the files are to be closed, the back-end portion of process 300 proceeds with step 370.

Step 370 is the entry to the back-end portion of process 300. Note that step 370 can be invoked from either of steps 365 or 368. In step 370, process 300 determines whether memory file 355 was opened (see steps 315 and 320). If memory file 355 was opened, then process 300 advances to step 372. If memory file 355 was not opened, then process 300 branches to step 384.

In step 372, process 300 determines the size of memory file 355, and attempts to allocate a buffer large enough to contain memory file 355. Process 300 then advances to step 374.

In step 374, process 300 determines whether the attempted allocation of a buffer in step 372 was successful. If the allocation was successful, then process 300 advances to step 376. If the allocation was not successful, because of a memory constraint for example, then process 300 branches to step 378.

In step 376, process 300 reads the memory file into the buffer that was allocated in step 372, and then writes that buffer into a permanent file. For example, if permanent file 340 exists, then process 300 may write the buffer to permanent file 340. Process 300 then advances to step 382.

In step 378, since step 372 could not allocate a buffer large enough to contain the entire memory file 355, process 300 attempts to allocate successively smaller buffers until the attempted allocation is successful. Process 300 then advances to step 380.

In step 380, process 300 performs an appropriate number of read and write operations until the entire contents of memory file 355 are transferred to a permanent file. For example, if permanent file 340 exists, then process 300 may write the buffer to permanent file 340. Process 300 then advances to step 382.

In step 382, process 300 closes and removes memory file 355. Process 300 then advances to step 384.

In step 384, if permanent file 340 exists, then process 300 closes permanent file 340. Process 300 then advances to step 386.

In step 386, process 300 returns to the code from which it was called.

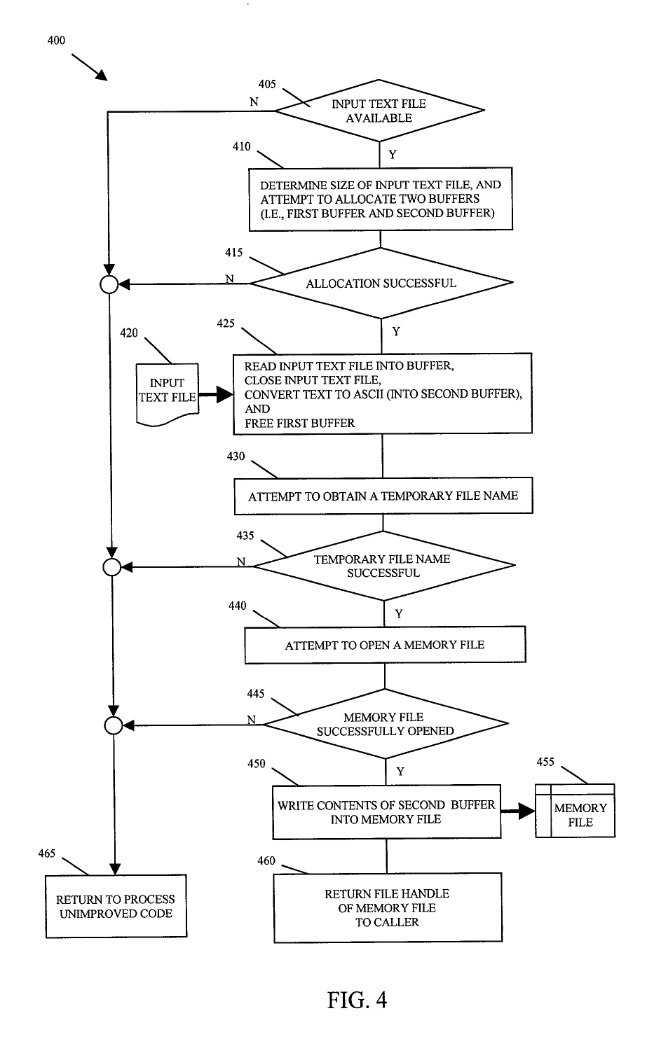

FIG. 4 is a flowchart of a process 400, which is a second exemplary implementation of improved code 120 as can incorporated into a ported source file B 115 (see FIGS. 1 and 2), in accordance with the present invention. Process 400 is described herein, by way of example and not limitation, in the context of an S/390 system environment.

FIG. 4 shows how an occurrence of an fopen( ) API, which does not use a memory file, can be improved upon by using the memory file capability. Process 400 converts data from EBCDIC to ASCII. The EBCDIC data is read from an input text file 420, and the ASCII data is written to a memory file 455. Process 400 is executed during execution of source file B 115 and begins with step 405.

A codeset is a mapping of character representations to hex values. For instance, in the EBCDIC IBM-1047 codeset, the hex value assigned to the capital letter “A” is ×‘C1’, while in the ASCII ISO8859-1 codeset the hex value for “A” is ×‘41’. Note that the number of converted bytes (in ASCII) will not be greater than the number of source bytes (in EBCDIC), even if working with multi-byte codesets. This is because the ASCII representation will not have any of the state-transition characters that are present in EBCDIC text streams when such streams contain both single- and multi-byte characters.

In step 405, process 400 determines whether input text file 420 is available. If input text file 420 is available, then process 400 advances to step 410. If input text file 410 is not available, then process 400 branches to step 465.

In step 410, process 400 determines the size of input text file 420. For example, on an S/390 system, this can be achieved using either (a) fstat( ), or (b) open( ) and Iseek( ). Also in step 410, process 400 attempts to allocate two buffers, i.e., a first buffer and a second buffer, each large enough to read in text file 420 in its entirety. Process 400 then advances to step 415.

In step 415, process 400 determines whether the attempted allocation of buffers in step 410 was successful. If the allocation was successful, then process 400 advances to step 425. If the allocation was not successful, that is, if both buffers cannot be allocated, because of memory constraints for example, then process 400 branches to step 465.

In step 425, process 400 opens and reads the entire text file 420 into the first buffer, and then closes text file 420. Process 400 converts the entire contents of the first buffer from a first data format, i.e., EBCDIC, to a second data format, i.e., ASCII. For example, in an embodiment of the present invention in the S/390 environment, the conversion is performed using an iconv ( . . . ) command. Those skilled in the art will appreciate that codeset conversion may be accomplished with APIs other than iconvo( ). Process 400 writes the converted data in ASCII format into the second buffer and frees the first buffer. Process 400 then advances to step 430.

In step 430, process 400 attempts to obtain a unique temporary file name. For example, in the S/390 environment, process 400 can use a tmpnam( ) command to obtain a temporary filename. Process 400 then advances to step 435.

In step 435, process 400 determines whether the attempt to obtain a temporary file name in step 430 was successful. If the temporary file name was successfully obtained, then process 400 advances to step 440. If the temporary file name was not successfully obtained, then process 400 branches to step 465.

In step 440, process 400 attempts to open a memory file 455 having the temporary file name obtained in step 430. For example, in the S/390 environment, either of the following commands can be used to open memory file 455:

fopen( const char *filename, const char *mode, type=memory)

or

fopen( const char *filename, const char *mode, type=memory(hiperspace))

After attempting to open memory file 455, process 400 advances to step 445.

In step 445, process 400 determines whether memory file 455 was successfully opened in step 440. If memory file 455 was successfully opened, then process 400 advances to step 450. If memory file 455 was not successfully opened, then process 400 branches to step 465.

In step 450, process 400 writes the entire contents of the second buffer, which contains the ASCII text (see step 425), into memory file 455, and frees the second buffer. Process 400 then advances to step 460.

In step 460, process 400 returns a file handle of memory file 455 to the code from which process 400 was called. For example, in the S/390 environment, this can be achieved by executing an fopen( ) call of memory file 455, and passing a handle of memory file 455 back to the calling code. Note that the handle obtained in step 460 can then be used for subsequent file access APIs by source file B 115 without further modification of source file B 115.

After completion of step 460, process 400 returns to the code from which it was called. For example, with reference to FIG. 2, upon successful completion of improved code 120, execution of portion 200 proceeds along path 220.

In step 465, process 400 reverts to normal, non-memory file processing. For example, with reference to FIG. 2, where improved code 120 is not successfully executed, execution of portion 200 proceeds from improved code 120 along path 215, and continues with execution of unimproved code 230.

FIG. 4 is a specific example showing how an occurrence of an fopen( ) API in the source file can be improved upon by using the memory file capability. The present invention can also provide an improvement where the code being ported uses a conventional open( ) API. In such a case, one of the fopen( ) calls listed above (i.e., fopen( . . . ,type=memory) or fopen( . . . ,type=memory(hiperspace)) ) is used instead, and the read( ), write( ), stat( ), etc. file operation APIs that are associated with the open( ) are replaced with their stream counterparts, fread( ), fwrite( ), fstat( ), etc. APIs.

Process 400 can be modified to handle a case where in step 410 there is enough memory for one buffer but not two buffers. If, in step 410, there is enough memory for one buffer but not two buffers, then an alternate method of performing the file conversion (see step 425) in a single call is to use the system( ) run-time library function:

system(“iconv -t ascii-codeset -f ebcdic-codeset textfile >tempfile”)

The contents of “tempfile” can be read into a single buffer before being written to memory file 455. In the S/390 environment, the current invention uses the iconv utility to perform codeset conversions, although any appropriate conversion software could be used instead.

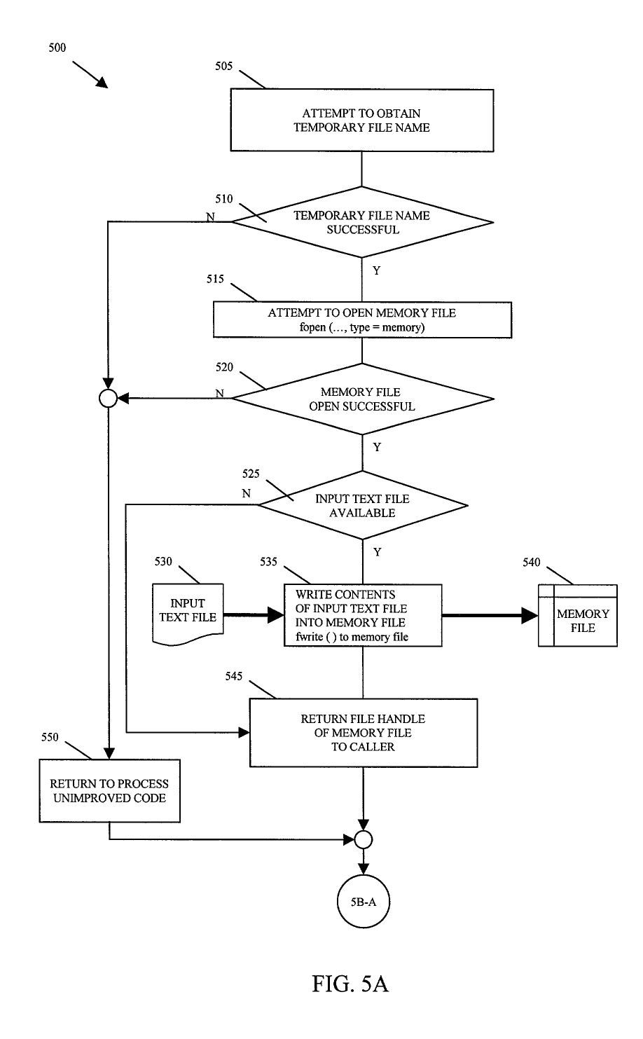

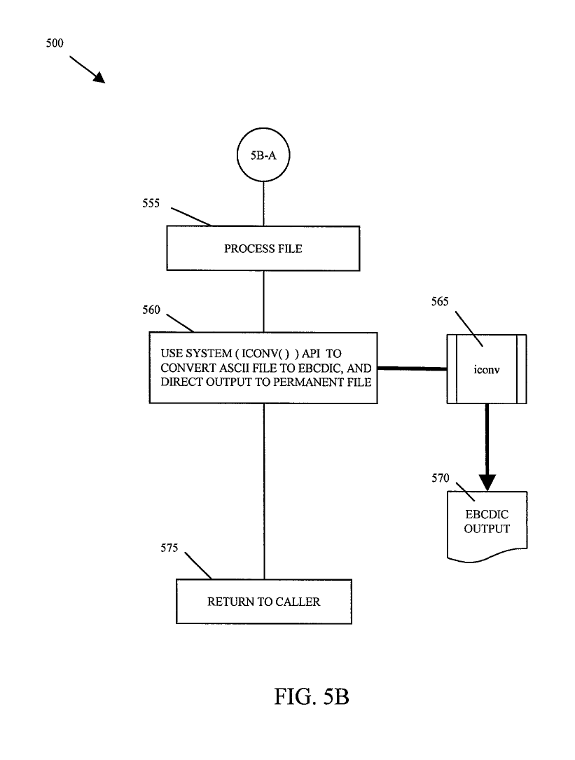

FIGS. 5A and 5B are a flowchart of a process 500, which is a another exemplary implementation of improved code 120 as can incorporated into a ported source file B 115, in accordance with the present invention. Process 500 is executed during execution of source file B 115 and allocates a memory file 540 into which ASCII text can be written. Also, in a case where an input is provided, e.g., input text file 530, process 500 generates a permanent output text file written in EBCDIC, i.e., EBCDIC output 570.

FIG. 5A illustrates a front-end portion of process 500 for opening memory file 540, and Fig. SB illustrates a back-end portion of process 500 for writing to EBCDIC output 570. The front-end of portion of process 500 commences with step 505.

In step 505, process 500 attempts to obtain a unique temporary file name. Process 500 then advances to step 510.

In step 510, if in step 505 the temporary file name was successfully obtained, then process 500 advances to step 515. If the temporary file name was not successfully obtained, then process 500 branches to step 550.

In step 515, process 500 attempts to open a memory file 540 having the temporary file name obtained in step 505. Process 500 then advances to step 520.

In step 520, process 500 determines whether memory file 540 was successfully opened in step 515. If memory file 540 was successfully opened, then process 500 advances to step 525. If memory file 540 was not successfully opened, then process 500 branches to step 550.

In step 525, process 500 determines whether input text file 530 is available. If input text file 530 is available, then process 500 advancers to step 535. If input text file 530 is not available, then process 500 branches to step 545.

In step 535, process 500 writes the contents of input text file 530 to memory file 540, in ASCII. Memory file 530 is thus a temporary work file in ASCII format. Process 500 then advances to step 545.

In step 545, process 500 returns a file handle of memory file 540 to the code from which process 500 was called. Note that the handle obtained in step 540 can then be used for a subsequent access of memory file 540. Such an access is described below when the back-end portion of process 500 is invoked, commencing with step 555.

In step 550, process 500 reverts to normal, non-memory file processing. For example, with reference to FIG. 2, where improved code 120 is not successfully executed, execution of portion 200 proceeds from improved code 120 along path 215, and continues with execution of unimproved code 230. When the normal, non-memory file processing code needs to send data to EBCDIC output 570, the back-end portion of method 500 is invoked, commencing with step 555.

As mentioned above, FIG. 5B illustrates the back-end portion of process 500, for writing to EBCDIC output 570. The back-end portion commences with step 555.

Step 555 is the entry to the back-end portion of process 500. In step 555, process 500 processes data that will subsequently be written to EBCDIC output 570. Note that execution of step 555 can be invoked from either of step 550 or step 545. If invoked from step 550, then step 555 processes data from a nonmemory file. On the other hand, if process 500 progressed through step 545, which provided a handle to memory file 540, then step 555 uses the handle to access and process data from memory file 540. Process 500 then advances to step 560.

In step 560, process 500 converts an entire file from ASCII to EBCDIC with a single “system” call that invokes codeset conversion software, such as iconv 565, and directs the output to EBCDIC output 570. Process 500 then advances to step 560.

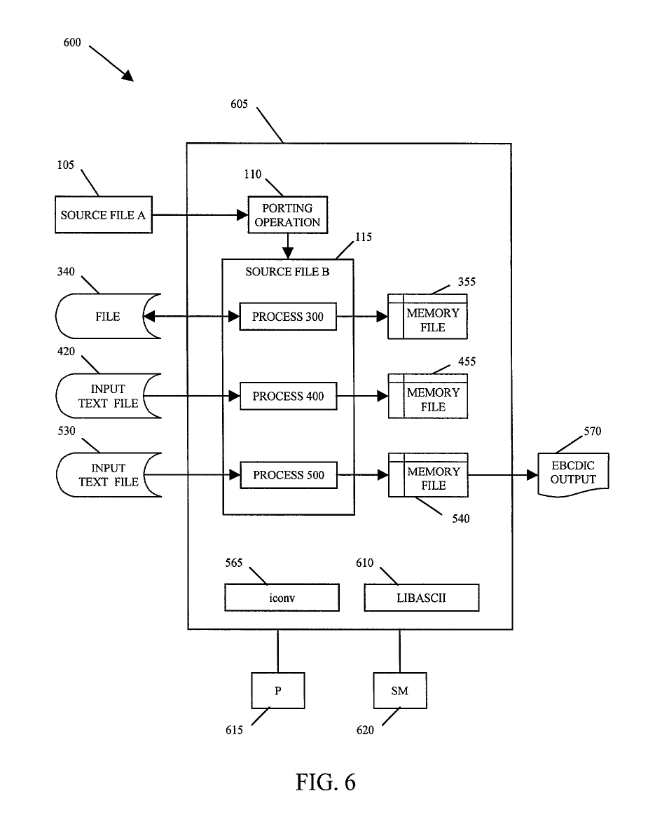

FIG. 6 is a block diagram of a computer system 600 configured for employment of the present invention. The principal components of computer system 600 are a processor 615 and an associated memory 605, also referred to as an address space.

Processor 615, in its preferred embodiment, is an S/390 processor. In a general case processor 615 can be any computer processor or general purpose microcomputer, such as one of the members of the SUN Microsystems family of computer systems, one of the members of the IBM Personal Computer family, or a reduced instruction set computer (RISC).

Memory 605 contains instructions and data, typically organized as files and program modules, for execution by processor 615. Memory 605 includes space for (a) porting operation 110, which produces source file B 115, (b) a routine, such as iconv routine 565, that performs codeset conversions, and (c) a set of APIs, such as LIBASCII 610, that allow program modules to execute in ASCII mode on an EBCDIC platform. Processes 300, 400 and 500, described earlier, resides as one or more program modules in source file B 115. Memory 605 also includes space for memory files 355, 455 and 540, as described earlier.

In FIG. 6, the organization of program modules within memory 605 is meant to represent a conceptual or hierarchical relationship between the program modules. Note that processes 300, 400 and 500 need not be physically located within source file B 115, but instead could be physically located external to source file B 115. For example, processes 300, 400 and 500 could be external routines invoked by a call from within source file B 115.

System 600 is represented herein as a standalone system, but it is not limited to such, and instead can be part of a networked system. Also, although system 600 is described herein as having porting operation 110 and source file B 115 installed into memory 605, porting operation 110 and/or source file B 115 can reside on an external storage media 620 for subsequent loading into memory 525. Storage media 620 can be any conventional storage media, including, but not limited to, a floppy disk, a compact disk, a magnetic tape, a read only memory, or an optical storage media. Storage media 620 could also be a random access memory, or other type of electronic storage, located on a remote storage system and coupled to memory 605.

In a practical setting, one of the first tasks that must be completed when porting code is to get the ported code to work as expected. In other words, functionality is the first order of business. However, if a working application is being ported, it is working already (on the platform from which it is being ported) and therefore the code is adequate to the tasks the application performs. As a porting strategy whose goal is the fastest possible implementation, therefore, it behooves developers to attempt to get the code working on the new platform with as few changes as possible, since redesign will almost inevitably introduce new bugs. After finctionality is achieved for the ported code, the developer's attention can be turned to other matters, such as performance. When performance profiles are considered, the developer's attention may be turned to file handling.

It should be understood that various alternatives and modifications of the present invention could be devised by those skilled in the art. The present invention is intended to embrace all such alternatives, modifications and variances that fall within the scope of the appended claims.

What is claimed is:

1. A method for enhancing source code for execution on a computer platform that has a capability to employ a memory file, said method comprising:
recognizing an occurrence of a first instruction in said source code that does not utilize said capability; and
supplementing said source code with a second instruction that utilizes said capability.

2. The method of claim 1, wherein said recognizing and said supplementing are performed when porting said source code from a first source file to a second source file.

3. The method of claim 1, wherein said supplementing provides said second instruction as part of a module for opening a memory file for use as a temporary work file during execution of said source code.

4. The method of claim 3, wherein said module is also for providing a handle for use by said source code to access said memory file subsequent to said opening of said memory file.

5. The method of claim 3,
wherein said first instruction is for opening a permanent file, and
wherein said module is also for reading data from said permanent file, and writing said data to said memory file.

6. The method of claim 3,
wherein said first instruction is for reading data in EBCDIC format, and
wherein said module is also for reading said data, converting said data from EBCDIC format to ASCII format, and writing said data to said memory file in ASCII format.

7. The method of claim 3,
wherein said first instruction is for reading data in ASCII format, and
wherein said module is also for reading said data, and writing said data to said memory file in ASCII format.

8. The method of claim 7, wherein said module is also for converting said data from said memory file into EBCDIC format, and writing said data in EBCDIC format to a permanent file.

9. A method for enhancing source code for execution on a computer platform that has a capability to employ a memory file, comprising:
recognizing an occurrence of a first instruction in said source code that does not utilize said capability; and
supplementing said source code with a module that opens a memory file for use as a temporary work file during execution of said source code,
wherein said recognizing and supplementing are performed when porting said source code from a first source file to a second source file.

10. A system for enhancing source code for execution on a computer platform that has a capability to employ a memory file, said system comprising a processor for:
recognizing an occurrence of a first instruction in said source code that does not utilize said capability; and
supplementing said source code with a second instruction that utilizes said capability.

11. The system of claim 10, wherein said processor performs said recognizing and said supplementing when porting said source code from a first source file to a second source file.

12. The system of claim 10, wherein said supplementing provides said second instruction as part of a module for opening a memory file for use as a temporary work file during execution of said source code.

13. The system of claim 12,
wherein said first instruction is for opening a permanent file, and
wherein said module is also for reading data from said permanent file, and writing said data to said memory file.

14. The system of claim 12,
wherein said first instruction is for reading data in EBCDIC format, and
wherein said module is also for reading said data, converting said data from EBCDIC format to ASCII format, and writing said data to said memory file in ASCII format.

15. The system of claim 12,
wherein said first instruction is for reading data in ASCII format, and
wherein said module is also for reading said data, and writing said data to said memory file in ASCII format.

16. A system for enhancing source code for execution on a computer platform that has a capability to employ a memory file, said system comprising a processor for:
recognizing an occurrence of a first instruction in said source code that does not utilize said capability; and
supplementing said source code with a module that opens a memory file for use as a temporary work file during execution of said source code,
wherein said recognizing and supplementing are performed when porting said source code from a first source file to a second source file.

17. A storage media for enhancing source code for execution on a computer platform that has a capability to employ a memory file, said storage media comprising instructions for controlling a processor for:
recognizing an occurrence of a first instruction in said source code that does not utilize said capability; and
supplementing said source code with a second instruction that utilizes said capability.

18. The storage media of claim 17, wherein said instructions are for controlling said processor to perform said recognizing and said supplementing when porting said source code from a first source file to a second source file.

19. The storage media of claim 17, wherein said supplementing provides said second instruction as part of a module for opening a memory file for use as a temporary work file during execution of said source code.

20. The storage media of claim 19,
wherein said first instruction is for opening a permanent file, and
wherein said module is also for reading data from said permanent file, and writing said data to said memory file.

21. The storage media of claim 19,
wherein said first instruction is for reading data in EBCDIC format, and
wherein said module is also for reading said data, converting said data from EBCDIC format to ASCII format, and writing said data to said memory file in ASCII format.

22. The storage media of claim 19,
wherein said first instruction is for reading data in ASCII format, and
wherein said module is also for reading said data, and writing said data to said memory file in ASCII format.

23. A storage media for enhancing source code for execution on a computer platform that has a capability to employ a memory file, said storage media comprising instructions for controlling a processor for:
recognizing an occurrence of a first instruction in said source code that does not utilize said capability; and
supplementing said source code with a module that opens a memory file for use as a temporary work file during execution of said source code,
wherein said recognizing and supplementing are performed when porting said source code from a first source file to a second source file.
